(19) United States
(12) Patent Application Publication
(10) Pub. No.: US 2010/0032426 A1
(43) Pub. Date: Feb. 11, 2010

(54) Toilet Seat Warmer

(76) Inventor: Richard A. Rendon, Colorado Springs, CO (US)

Correspondence Address: HANES & SCHUTZ, LLC, 102 SOUTH TEJON ST., SUITE 800, COLORADO SPRINGS, CO, 80903, US

(21) Appl. No.: 12/537,107

(22) Filed: Aug. 6, 2009

Related U.S. Application Data
(60) Provisional application No. 61/188,199, filed on Aug. 7, 2008.

(51) Int. Cl. H05B 3/34

(52) U.S. Cl. 219/528

(57) ABSTRACT

A warmer for warming a toilet seat having a lid is disclosed. The warmer has a heating pad and fastening means. The heating pad has a lower surface shaped to fit on top of a toilet seat and is configured to heat peripherally therearound. The fastening means is adapted to attach to the underside of the toilet seat lid. The fastening means is attached to the upper surface of the heating pad. When the lid is closed on the toilet seat, the heating pad is brought in contact with the toilet seat. When the lid is lifted for use, the heating pad is positioned away from the toilet seat.

This application claims the benefit of U.S. Provisional Application No. 61/188,199 filed on Aug. 7, 2008.

### BACKGROUND OF THE INVENTION

Toilet seats have been in use for many years. Often a user of the toilet seat finds that the temperature of the seat upon first sitting is uncomfortably cold.

### DESCRIPTION OF THE DRAWINGS

FIG. 1 is a perspective view of a toilet seat heating pad attached to an underside of a toilet seat lid.

FIG. 2 is a perspective view of the toilet seat heating pad partially detached from the toilet seat lid.

### DETAILED DESCRIPTION OF THE INVENTION

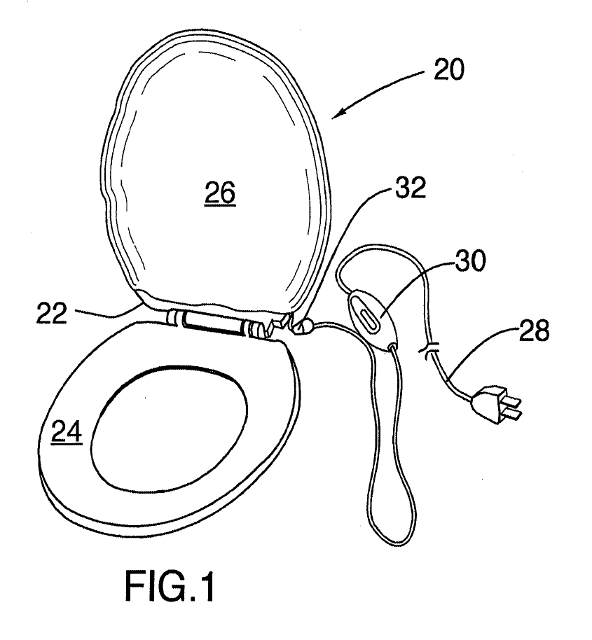

Turning to the drawings and more particularly to FIG. 1, we have a perspective view of a toilet seat heating pad 20 attached to an underside of a toilet seat lid 22. A method of heating a contoured toilet seat 24 having a toilet seat lid 22 comprises the steps of: a) providing a heating pad 20 shaped to attach beneath a toilet seat lid 22, said heating pad 20 configured to heat peripherally therearound; b) providing an attachment means to removably attach the toilet seat heating pad 20 to an under side of the toilet seat lid 22; and, c) attaching the heating pad 20 to a peripheral portion of the under side portion of the toilet seat lid 22. Then when the lid 22 is closed on the toilet seat 24, the heating pad 20 is carried by, and heats the toilet seat 24. When the lid 22 is lifted for use, the heating pad 20 is positioned away from the toilet seat 24 and not beneath a user, thereby remaining cleaner and unshifted from proper position for subsequent use.

In one embodiment, the heating pad 20 comprises a lower layer 26 which peripherally hangs beneath the toilet seat lid 22 when the toilet seat lid 22 is in a closed position then the peripheral heating elements therearound are carried on, and in direct proximity with the contoured toilet seat 24. In one embodiment, the heating pad 20 is provided with an electrical plug-in cord 28 having a level of heating selection switch 30. In one embodiment of the invention, the heating pad 20 comprises a receptacle 32 to removably detach the electrical power cord 28 therefrom for washing.

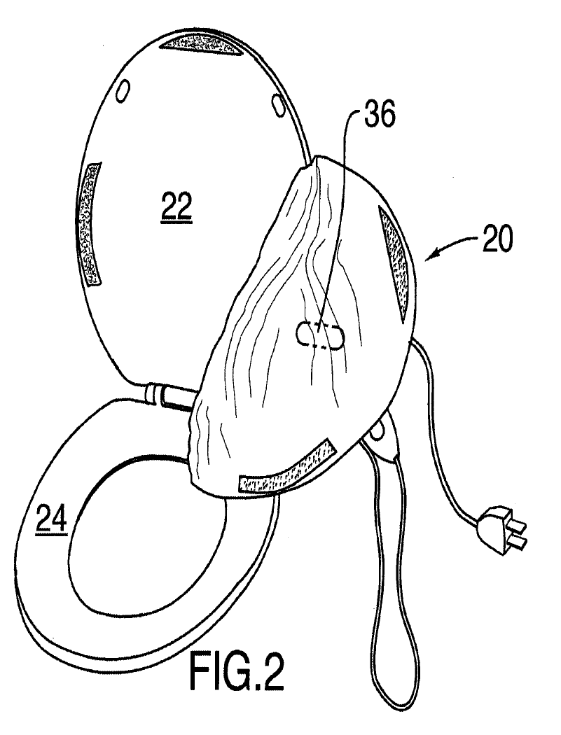

FIG. 2 is a perspective view of the toilet seat heating pad 20 partially detached from the toilet seat lid 22. In one embodiment of this invention, the heating pad 20 is removably attachable to the toilet seat lid 22 to facilitate removal for washing. As shown in FIG. 2 the heating pad 20 may be adhered to the toilet seat lid 22 with hook and loop fasteners.

In any aspect of the invention described above, the heating pad 20 may further comprise a position switch 36, positioned within the heating pad 20. Said switch 36, which, in one embodiment, is a mercury switch, is configured to turn on the heating pad 20 only when the heating pad (and lid) are in a horizontal position. This enables a user to turn on the heating pad 20 prior to use merely by lowering the lid to a horizontal position. It eliminates the necessity of bending over to pull the electrical cord 28 from a wall outlet (not shown).

This invention relates to a toilet seat employing a lightweight and durable toilet seat heating pad which is carried by the toilet seat lid. The heating pad may readily be secured to an existing toilet seat, and thereafter be temporarily removed for cleaning.

The invention is an electrically warmed pad that may be attached to the underside of an existing toilet seat lid. When the lid is in the horizontal/down position, it warms the seat. Insulated resistance wires are attached to thin fire retardant insulation material and encased inside a waterproof material that is hermetically sealed. The shapes of the pads match the shapes of common toilet seats. An electric cord attached to the resistance wires extends outside the pad and has a controller and GFCI plug inline. The controller allows the pads warmth to be adjusted at various levels and the GFCI plug, with test and reset buttons, provides redundant safety. The pad is attached to the underside of the lid with Velcro pieces allowing for easy installation and removal. Once attached to the underside of the lid, plugged into an electric wall outlet, the controller turned to one of the “on” positions, the pad is made to remain safely on for long periods of time. When the lid is in the down position it will warm the seat so that it is comfortable when nature calls.

The heating pad is attached to the underside of the existing toilet lid allowing for:

a. the seat to be warmed while the lid is in the horizontal/down position. By heat transfer, the seat is warm and comfortable to the user when the lid is raised for use.

b. the owner to use their existing toilet seat. This keeps the cost low and allows the owner to use the seat itself unaltered in any manner.

c. the owner to use decorative lid coverings or maintain the same aesthetic as the existing toilet lid top. The pad can't be seen when the lid is in the horizontal position.

The heating pad is easily detachable and attachable to the underside of any existing toilet lid with use of small Velcro pieces. There are no unsightly ties or straps that get soiled and can't be cleaned.

The heating pad provides efficient warmth around entire toilet seat using insulated resistance wire sewn onto the soft, fire retardant, insulation material inside of an outer vinyl cover.

The heating pad is durable using thin vinyl material that holds up under heat and wetness. In one embodiment, it is made of the same material used for heating pads.

The heating pad is washable, wipeable, and wet safe using a water repelling vinyl cover and hermetically sealed seams around the perimeter and the cord. This allows for easy wiping rather than placing it into a washer.

The vinyl cover allows for print, pictures, or logos to be placed on the pad. This allows for safety precautions, instructions, markings and marketing to be shown for added safety, ease of use, humor, or advertisement.

Temperature is controlled with three settings of low, medium, and high, allowing for customized adjustments based on user preference and the ambient temperature. It has been found that each person has a preference on heat and prefers to be able to adjust it to their liking. Some people want to simply remove the chill and others want the comfort of a warmer seat than their body temperature. However, the heat settings are limited in the high position to a temperature that is safe to the touch.

In one embodiment, the electric cord is nine feet long, precluding the need for an extension cord in most applications. The controller is three feet from the pad allowing for the controller to be positioned in a convenient location but not too close to the lid where it could hinder lowering or raising.

Adhesive-back wall hangars may be included for keeping cord and controller off of the floor for added safety precaution and for aesthetics. If an extension cord is needed, the wall hangars may be used to ensure the connection is raised off of the floor for added safety against a wet floor shock hazard.

The color of the vinyl can be chosen to match the color of the toilet seat for aesthetic enhancement.

The pad is carefully manufactured to be very thin (approximately ¼ inch) so that when both the lid and the seat are in the raised/vertical/up position, the seat will not fall forward. This is especially important for men when they need and want the seat to remain in the vertical position. Other thicker products cause frustration because the seat will not remain vertical.

In one embodiment, the plug is GFCI with a reset and test switch for added safety. Although most building codes require GFCI outlets in the bathrooms, not all outlets are maintained as GFCI. This is an important added safety feature giving the owner an added level of confidence and safety.

The heating pad is lightweight, thin, and sized so that it fits in most travel bags and suit cases. The size and light weight coupled with its ease of installation and removal allow for it to easily be placed in a suitcase and taken on a trip.

The heating pad may be pad is sized to fit both the elongated and round versions of toilet seats commonly in use today.

The power demand for the heating pad is relatively low, allowing for continuous use at low cost. It allows a lower thermostat temperature for the entire house because the user does not have to sit on a cold toilet seat.

In other embodiments, the power supplied to the heating pad may be low voltage, battery powered, or mechanically powered. Power to the heating pad may also be controlled remotely.

It is an advantage of this invention that the toilet seat heater attaches to and is carried by a toilet seat lid. Because the toilet seat heater is attached to the toilet seat lid it need not be secured sufficiently to maintain its position when an individual is seated and shifts thereon. It is an advantage of this invention that the toilet seat heater does not get as dirty as a toilet seat cover positioned beneath and in close proximity to the toilet bowl during use. It is yet a further advantage of this invention that the toilet seat heater may be readily removed and replaced after washing. It is yet a further advantage of this invention that the toilet seat heater will allow individuals to easily and inexpensively alter their existing toilet seats to enjoy the comfort of a warm toilet seat. It is another advantage of this invention that the toilet seat heater, because of its adequate yet effective position on the toilet seat lid cover, is lightweight, durable, and effective.

One aspect of this invention provides for a method of heating a contoured toilet seat having a toilet seat lid comprising the steps of: providing a heating pad shaped to attach beneath a toilet seat lid, said heating pad configured to heat peripherally therearound; providing an attachment means to removably attach the toilet seat heater to an under side of the toilet seat lid; and, attaching the heating pad to a peripheral portion of the under side portion of the toilet seat lid. Then when the lid is closed on the toilet seat, the heating pad is carried by, and heats the toilet seat. When the lid is lifted for use, the heating pad is positioned away from the toilet seat and not beneath a user, thereby remaining cleaner and unshifted from proper position for subsequent use.

In one embodiment of the invention, the heating pad is removably attachable to the toilet seat lid to facilitate removal for washing. In one embodiment of the invention the heating pad is adhered to the toilet seat lid with hook and loop fasteners. In yet another embodiment of the invention the heating pad comprises a lid cover having a fabric top side portion which is positioned over a top side portion of the toilet seat lid.

In yet another embodiment of this invention, the heating further comprises a mercury switch, positioned within the heating pad, said switch configured to turn on the heating pad only when the heating pad (and lid) are in a horizontal position.

The foregoing description is only illustrative of the invention. Various alternatives, modifications, and variances can be devised by those skilled in the art without departing from the invention. Accordingly, the present invention embraces all such alternatives, modifications, and variances that fall within the scope of the described invention.

What is claimed is:

1. A warmer for warming a toilet seat having a lid, the warmer comprising:
a heating pad having upper and lower surfaces, the lower surface shaped to fit on top of a toilet seat, the heating pad configured to heat peripherally therearound;
fastening means adapted to attach to the underside of the toilet seat lid, the fastening means attached to the upper surface of the heating pad; and
wherein the lid being closed on the toilet seat brings the heating pad in contact with the toilet seat and the lid being lifted for use positions the heating pad away from the toilet seat.

2. The warmer of claim 1 further including an electrical plug-in cord for providing electrical power to the heating pad

3. The warmer of claim 1 further including a selection switch for controlling the amount of heat produced by the heating pad.

4. The warmer of claim 1 wherein the fastening means is a removable fastening means for removable attachment of the upper surface of the heating pad to the underside of the toilet seat lid.

5. The warmer of claim 1 wherein the heating pad has a thickness of no more than about one quarter of an inch.
